(19) United States
(12) Patent Application Publication
(10) Pub. No.: US 2026/0094173 A1
(43) Pub. Date: Apr. 2, 2026

(54) VISITOR ANALYSIS SYSTEM, VISITOR ANALYSIS METHOD, AND RECORDING MEDIUM

(71) Applicant: NEC Corporation, Minato-ku, Tokyo (JP)

(72) Inventors: Koki SAKAI, Tokyo (JP); Yoko TANAKA, Tokyo (JP); Nozomi MATSUMOTO, Tokyo (JP)

(73) Assignee: NEC Corporation, Minato-ku, Tokyo (JP)

(21) Appl. No.: 19/110,509

(22) PCT Filed: Oct. 7, 2022
(86) PCT No.: PCT/JP2022/037594

§ 371 Date: Mar. 11, 2025

(51) Int. Cl. G06Q 30/0201; G06Q 30/0251; G08G 1/017

(52) U.S. Cl. CPC G06Q 30/0201; G06Q 30/0266; G08G 1/0175

(57) ABSTRACT

This visitor analysis system comprises: an access unit that accesses an image recording device of an information system that includes a camera group, which is disposed in a distributed manner in a prescribed area and which is for imaging a vehicle traveling on a road in said area, and said image recording device, which stores data about the time at which the vehicle was imaged and data about the site at which the vehicle was imaged in association with each other; a vehicle identifying unit that identifies a vehicle that has entered a prescribed region; and a start point identifying unit that collates the identified vehicle with an image stored in the image recording device, and identifies the start point of the vehicle on the basis of the data on the time and the data on the site that have been associated with the matching image.

### TECHNICAL FIELD

The present disclosure relates to a visitor analysis system, a visitor analysis method, and a recording medium.

### BACKGROUND ART

PTL 1 discloses an example of an information processing device having a function of reading information about a license plate of a vehicle from an image of the vehicle entering a parking lot of a store and accumulating information about a region included in the read information of the license plate as vehicle information.

### CITATION LIST

### Patent Literature

PTL 1: JP 2008-003993 A

### Summary of Invention

### Technical Problem

The information processing device of PTL 1 describes analyzing a regional tendency of a vehicle entering a parking lot by using information about a region included in information about a license plate of the vehicle. However, there is a problem that it is not possible to analyze a trading zone by a region finer than the region information included in the information of the license plate of the vehicle.

An object of the present disclosure is to provide a visitor analysis system, a visitor analysis method, and a recording medium that can facilitate analysis of a visitor who has visited a commercial facility or the like.

### Solution to Problem

According to a first aspect, provided is a visitor analysis system including an access means for being capable of accessing an image recording device of an information system that includes a camera group that is dispersedly disposed in a predetermined area and images a vehicle traveling on a road in the area and the image recording device that stores an image captured by the camera group, data of a time at which the vehicle is imaged, and data of a site at which the vehicle is imaged in association with each other, a vehicle identification means for identifying a vehicle that has entered a predetermined region, and a departure place identification means for collating the identified vehicle with an image stored in the image recording device to identify a departure place of the vehicle based on data of the time and data of the site that have been associated with the matching image.

According to a second aspect, provided is a visitor analysis system including an image access means dispersedly disposed in a predetermined area and for being capable of accessing a camera group that images a vehicle traveling on a road in the area, a vehicle identification means for identifying a vehicle that has left a predetermined region, and a destination identification means for referring to an image captured by the camera group for the identified vehicle and identifying a destination of the vehicle.

According to a third aspect, provided is a visitor analysis method executed by a computer being capable of accessing an image recording device of an information system that includes a camera group that is dispersedly disposed in a predetermined area and images a vehicle traveling on a road in the area and the image recording device that stores an image captured by the camera group, data of a time at which the vehicle is imaged, and data of a site at which the vehicle is imaged in association with each other, the method including identifying a vehicle that has entered a predetermined region, and collating the identified vehicle with an image stored in the image recording device to identify a departure place of the vehicle based on data of the time and data of the site that have been associated with the matching image.

According to a fourth aspect, provided is a visitor analysis method executed by a computer being capable of accessing a camera group dispersedly disposed in a predetermined area and imaging a vehicle traveling on a road in the area, the method including identifying a vehicle that has left a predetermined region, and referring to an image captured by the camera group and identifying a destination of the identified vehicle.

According to a fifth aspect, provided is a recording medium recording a program for causing a computer being capable of accessing an image recording device of an information system that includes a camera group that is dispersedly disposed in a predetermined area and images a vehicle traveling on a road in the area and the image recording device that stores an image captured by the camera group, data of a time at which the vehicle is imaged, and data of a site at which the vehicle is imaged in association with each other to execute the steps of identifying a vehicle that has entered a predetermined region, and collating the identified vehicle with an image stored in the image recording device to identify a departure place of the vehicle based on data of the time and data of the site that have been associated with the matching image.

According to a sixth aspect, provided is a recording medium recording a program for causing a computer being capable of accessing a camera group dispersedly disposed in a predetermined area and imaging a vehicle traveling on a road in the area to execute the steps of identifying a vehicle that has left a predetermined region, and referring to an image captured by the camera group and identifying a destination of the identified vehicle.

### Advantageous Effects of Invention

According to the present disclosure, there are provided an object recognition system, an object recognition method, and a recording medium capable of facilitating analysis of a customer who visits a commercial facility or the like.

### BRIEF DESCRIPTION OF DRAWINGS

FIG. 1 is a diagram illustrating a configuration of an example embodiment of the present disclosure.

FIG. 2 is a flowchart illustrating an operation of an example embodiment of the present disclosure.

FIG. 3 is a diagram for describing an operation of an example embodiment of the present disclosure.

FIG. 4 is a diagram for describing an operation of an example embodiment of the present disclosure.

FIG. 5 is a block diagram illustrating a configuration of a visitor analysis system according to the first example embodiment of the present disclosure.

FIG. 6 is a diagram illustrating an example of visitor analysis information recorded in a visitor analysis information storage means of the visitor analysis system according to the first example embodiment of the present disclosure.

FIG. 7 is a flowchart illustrating an operation of the visitor analysis system according to the first example embodiment of the present disclosure.

FIG. 8 is a flowchart illustrating an example of a counting operation of the visitor analysis system according to the first example embodiment of the present disclosure.

FIG. 9 is a diagram illustrating an example of visitor counting information for each time zone counted by the visitor analysis system according to the first example embodiment of the present disclosure.

FIG. 10 is a diagram illustrating an example of visitor counting information for each departure place counted by the visitor analysis system according to the first example embodiment of the present disclosure.

FIG. 11 is a block diagram illustrating a configuration of a visitor analysis system according to the second example embodiment of the present disclosure.

FIG. 12 is a flowchart illustrating an operation of a visitor analysis system according to the second example embodiment of the present disclosure.

FIG. 13 is a diagram illustrating an example of an advertisement distribution condition created by a visitor analysis system according to the second example embodiment of the present disclosure.

FIG. 14 is a diagram for describing the operation of the visitor analysis system according to the second example embodiment of the present disclosure.

FIG. 15 is a block diagram illustrating a configuration of a visitor analysis system according to the third example embodiment of the present disclosure.

FIG. 16 is a flowchart illustrating an operation of a visitor analysis system according to the third example embodiment of the present disclosure.

FIG. 17 is a block diagram illustrating a configuration of a visitor analysis system according to the fourth example embodiment of the present disclosure.

FIG. 18 is a diagram illustrating a configuration of a computer that can function as the object recognition system of the present disclosure.

### EXAMPLE EMBODIMENT

First, an outline of an example embodiment of the present disclosure will be described with reference to the drawings. The reference numerals in the drawings attached to this outline are attached to respective elements for convenience as an example for assisting understanding, and are not intended to limit the present disclosure to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with equipment (including a computer) inside or outside the device via a communication interface regardless of wired or wireless. Although there are ports and interfaces at connection points of input to output of each block in the drawing, illustration thereof is omitted.

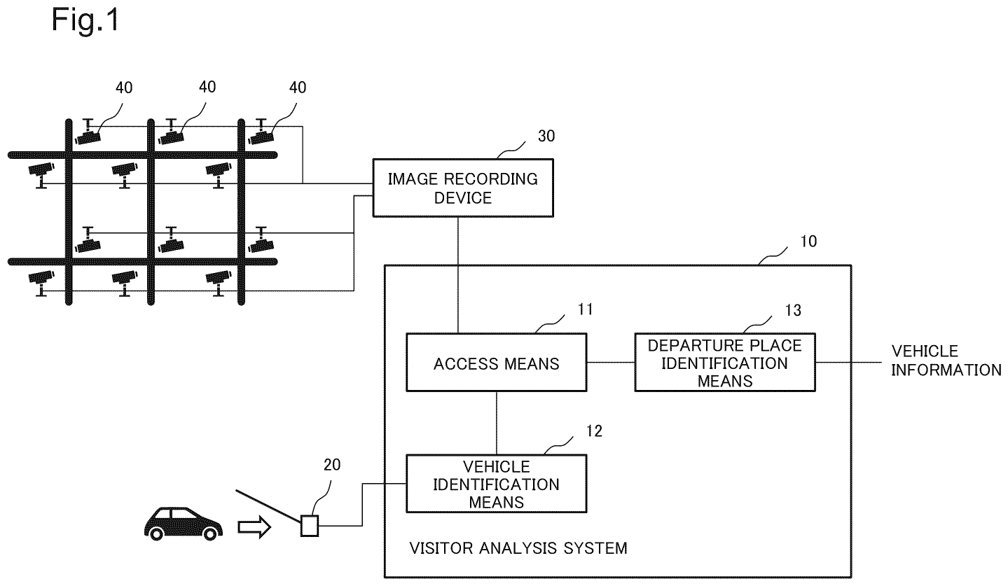

In an example embodiment of the present disclosure, as illustrated in FIG. 1, the present disclosure can be achieved by a visitor analysis system 10 including an access means 11, a vehicle identification means 12, and a departure place identification means 13.

More specifically, the access means 11 achieves an access of an information system including an image recording device 30 that stores
an image captured from the camera group 40, data of a time when the vehicle is imaged, and data of a site where the vehicle is imaged in association with each other to the image recording device 30. The camera group 40 is dispersedly disposed in a predetermined area, and can image a vehicle traveling on a road in the area.

The vehicle identification means 12 identifies a vehicle that has entered a predetermined region, for example, a parking lot or a pickup-only area in a buy online pickup in store (BOPIS). As a method of identifying the vehicle by the vehicle identification means 12, a method of identifying the vehicle based on license plate information obtained by image recognition of an image of a license plate obtained from an entrance gate device 20 of the parking lot can be used. Instead of using the license plate information, it is also possible to adopt a method of identifying the vehicle by using the characteristics of the image (image) of the vehicle itself. Instead of using the license plate information, it is also possible to adopt a method of identifying a vehicle by associating a vehicle ID or the like obtained by communicating with the vehicle with an image (image) of the vehicle.

The departure place identification means 13 refers to the image stored in the image recording device 30 for the identified vehicle, identifies a departure place in the area of the vehicle, and outputs the departure place as vehicle information to a predetermined output destination.

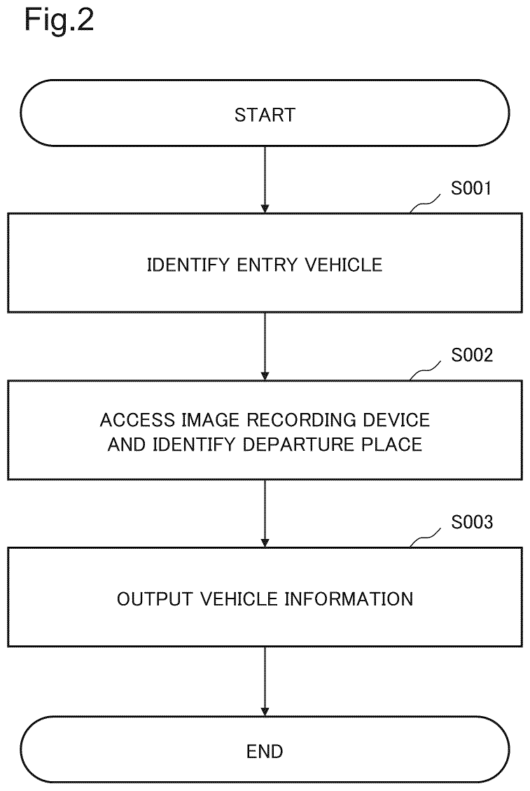

FIG. 2 is a flowchart illustrating a visitor analysis method. As illustrated in FIG. 2, the visitor analysis system 10 configured as described above first identifies a vehicle that has entered a predetermined region (step S001). Next, the visitor analysis system 10 accesses the image recording device 30 and identifies a departure place of the identified vehicle (step S002). Finally, the visitor analysis system 10 outputs the vehicle and a departure place of the vehicle in association with each other as vehicle information (step S003).

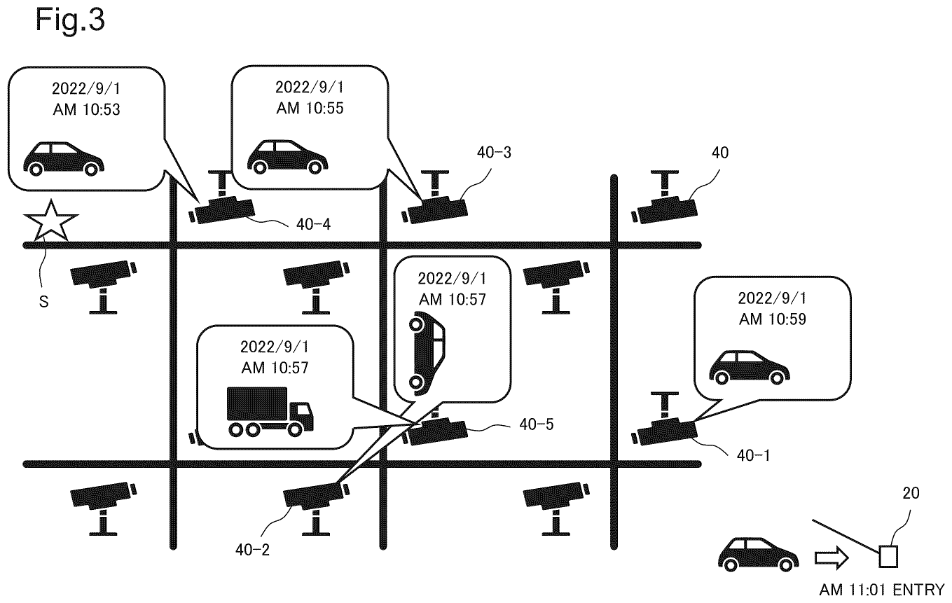

FIG. 3 is a diagram for describing a method of identifying a departure place of the vehicle by the departure place identification means 13. For example, as illustrated in FIG. 3, it is assumed that the entrance of the vehicle into the entrance gate device 20 of the parking lot is detected. In this case, the departure place identification means 13 of the visitor analysis system 10 searches for an image showing the detected vehicle from the image stored in the image recording device 30, and identifies the departure place of the vehicle by tracking the imaging time and position. More specifically, the departure place identification means 13 collates the identified vehicle with the image stored in the image recording device 30, and identifies the departure place of the vehicle based on data of the time and data of the site (x1, y1 to x4, y4) associated with the matched image. In the example of FIG. 3, the departure place identification means 13 identifies the departure place S from the site associated with the image by tracking the images captured by the cameras 40-1, 40-2, 40-3, and 40-4. In the example of FIG. 3, the image stored in the camera 40-5 can be acquired, but since the vehicle shown is different, the departure place identification means 13 rejects these images. A case where the actual departure place of the vehicle is outside the area where the camera 40 is disposed is assumed. In this case, a position that appears first in the camera 40 in a series of routes of the vehicle may be regarded as the departure place. For example, a site where the vehicle is imaged at the earliest time in the day when the vehicle is detected is identified as the departure place. In tracking the position of the vehicle, a time to go back may be limited. For example, in a case where the time to go back is set to 3 hours in the example of FIG. 3, a site where the vehicle is imaged at the earliest time in the time from 8:01 AM to 11:01 AM is identified as the departure place.

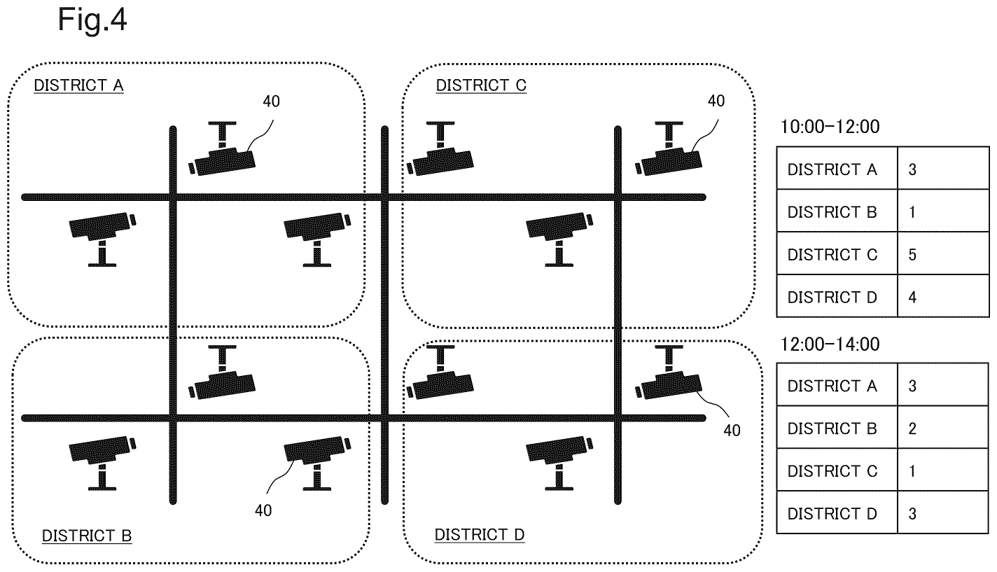

According to the visitor analysis system 10 operating as described above, it is possible to collect statistical data indicating where a vehicle that has entered a specific area such as a parking lot or a pickup-only area has come from. For example, as illustrated in FIG. 4, the predetermined area in which the camera 40 is disposed is divided into four zones, and the number of vehicles visiting from each zone can be grasped. Such statistical data can be counted for each time zone. For example, in the example of FIG. 4, the number of vehicles visiting from the district C from 12:00 to 14:00 is one, a rapidly decreases from five at the previous time zone 10:00 to 12:00. By obtaining this result, it is possible to make hypotheses such as traffic congestion on a road on a route from the district C, congestion relaxation of a parking lot of a competing store, and the like as a reason for the reduction in the number of store visitors and take a measure for each of them.

As described above, according to the present example embodiment, it is possible to facilitate analysis of a customer who has visited a commercial facility or the like.

### First Example Embodiment

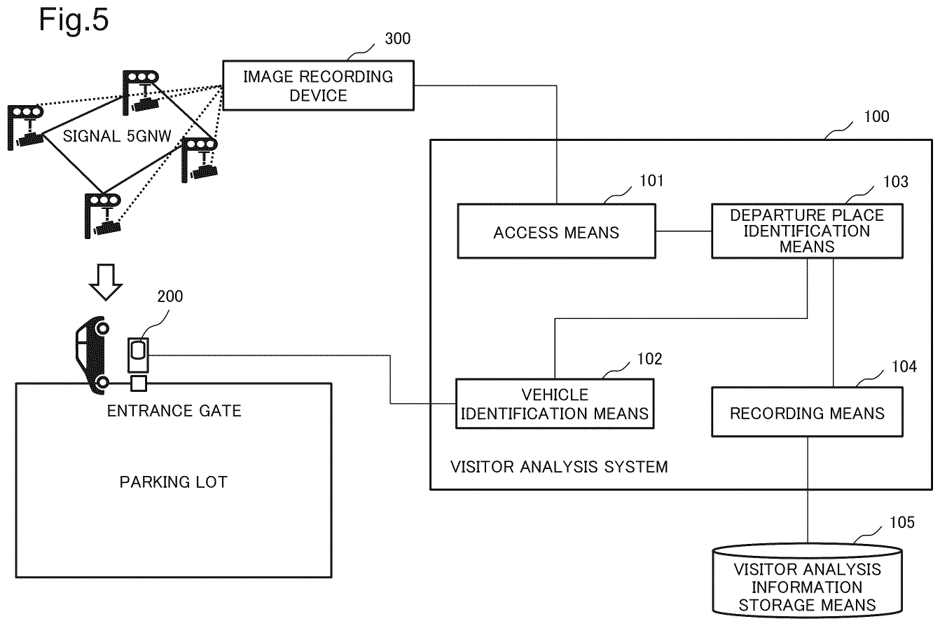

Next, the first example embodiment in which a visitor visiting a commercial facility can be analyzed using a camera installed at a traffic light at an intersection will be described in detail with reference to the drawings. FIG. 5 is a block diagram illustrating a configuration of a visitor analysis system according to the first example embodiment of the present disclosure. Referring to FIG. 5, a visitor analysis system 100 including an access means 101, a vehicle identification means 102, a departure place identification means 103, and a recording means 104 is shown.

The access means 101 acquires an image captured by each camera from an image recording device 300 that records the image captured by the camera installed at the traffic light at the intersection. The position and orientation of the camera can be uniquely identified from the camera ID and the like, and the position of the subject can be grasped from an image captured in an image of an any camera.

An entrance gate device 200 is a gate device installed at an entrance of a parking lot of a commercial facility, is provided with a camera, captures images of a license plate and a vehicle, and performs entrance/exit management using these pieces of information.

The image recording device 300 is a device that temporarily records an image captured by a camera connected to a network. As these images, images captured by cameras used for traffic control, analysis of traffic congestion, and the like, such as a signal 5G network (5GNW) can be used. The image recording device 300 may manage an image captured by a camera other than the camera of the signal 5G network (5GNW). Examples of such a camera include a security camera and a camera of a multifunctional street terminal called a smart pole installed on a street.

Upon receiving the images of the license plate of the vehicle entering the parking lot and the vehicle from the entrance gate device 200, the vehicle identification means 102 passes these pieces of information to the departure place identification means 103 and requests the identification of the departure place.

Upon receiving the request for identifying a departure place from the vehicle identification means 102, the departure place identification means 103 accesses the image recording device 300 via the access means 101, and identifies the past movement (visit route) of the vehicle whose departure place is requested to identify. When the identification of the past movement (visit route) of the vehicle is completed, the departure place identification means 103 requests the recording means 104 to register the past movement in a visitor analysis information storage means 105. As a mechanism in which the departure place identification means 103 identifies and tracks the vehicle whose departure place is requested to identify, it is possible to use a technique of tracking the vehicle using at least one of a license plate and characteristics of an image of the vehicle used for traffic volume investigation, entrance/exit management of a parking lot, and the like.

The recording means 104 registers data of the past movement (route) of the vehicle that has entered the parking lot in the visitor analysis information storage means 105. The visitor analysis information storage means 105 stores the visitor analysis information. In the example of FIG. 5, the visitor analysis information storage means 105 is disposed on the outside (storage on the network, etc.) of the visitor analysis system 10, but the visitor analysis information storage means 105 may be provided in the visitor analysis system 100.

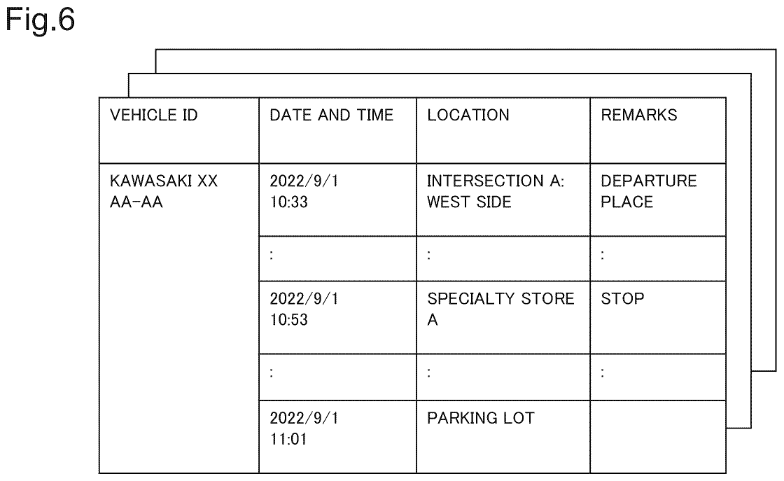

FIG. 6 is a diagram illustrating an example of visitor analysis information recorded in the visitor analysis information storage means 105 of the visitor analysis system according to the first example embodiment of the present disclosure. In the example of FIG. 6, information about the movement (visit route) identified for each vehicle entering the parking lot is registered. For example, in the example of FIG. 6, a movement (visit route) in which after the vehicle (vehicle ID: Kawasaki XX AA-AA) entering the parking lot at 11:01 on Sep. 1, 2022 was detected on the west side of the intersection A, visited the specialty store A and came to the parking lot is identified. By collecting such data for the vehicle that has entered the parking lot, it is possible to perform detailed analysis of a customer who has visited the commercial facility by car. In the example of FIG. 6, the intersection information and the store information are used as the expression form of the position of the vehicle, but the expression form of the position of the vehicle is not limited thereto. For example, it is a matter of course that the position and movement (visit route) of the vehicle may be grasped using a coordinate system such as latitude and longitude.

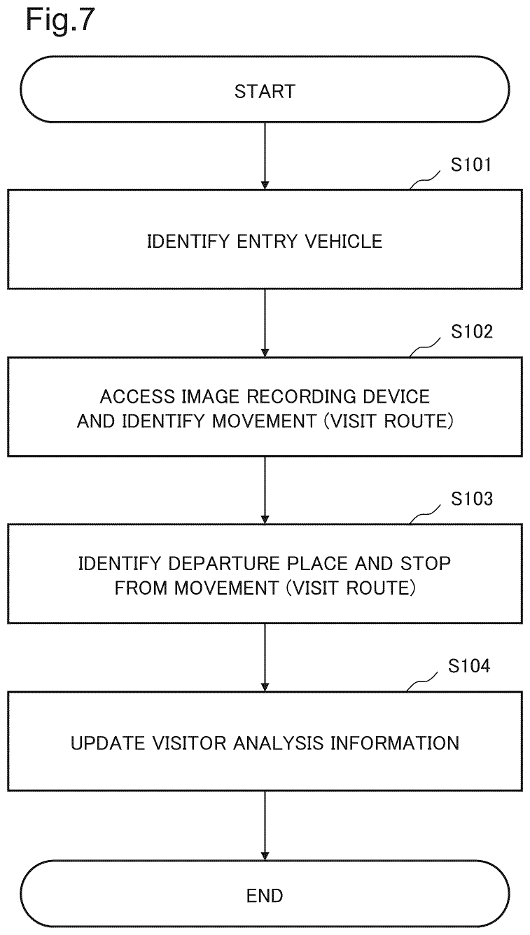

Next, the operation of the present example embodiment will be described in detail with reference to the drawings. FIG. 7 is a flowchart illustrating an operation of the visitor analysis system according to the first example embodiment of the present disclosure. Referring to FIG. 7, first, the visitor analysis system 100 identifies a vehicle that has entered the parking lot (step S101).

Next, the visitor analysis system 100 accesses the image recording device 300 and identifies the movement (visit route) of the vehicle entering the parking lot (step S102).

Next, based on the identified movement (visit route), the visitor analysis system 100 identifies a departure place of the vehicle that has entered the parking lot and a stop (in a case where there is a stop) that is a place that the vehicle has stopped by (step S103).

Next, the visitor analysis system 100 registers, in the visitor analysis information storage means 105, information including the identified departure place of the vehicle and the stop (in a case where there is the stop) as the visitor analysis information (step S104). By performing the above processing, data as illustrated in FIG. 6 is accumulated in the visitor analysis information storage means 105.

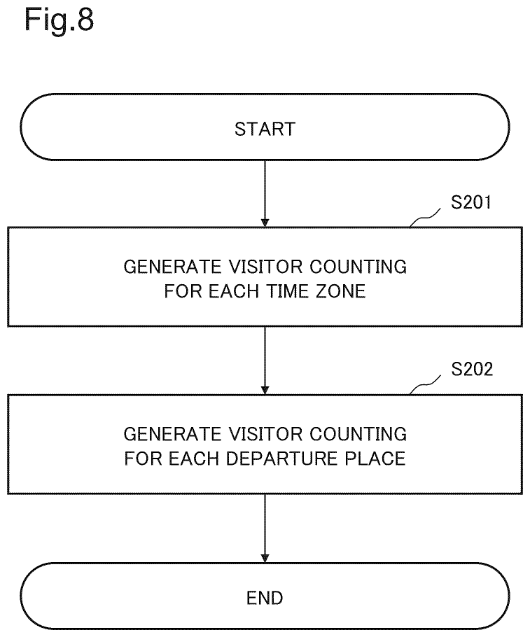

Thereafter, the visitor analysis system 100 performs a counting operation of the data accumulated in the visitor analysis information storage means 105 at a predetermined trigger. FIG. 8 is a flowchart illustrating an example of a counting operation of the visitor analysis system 100 of the present example embodiment.

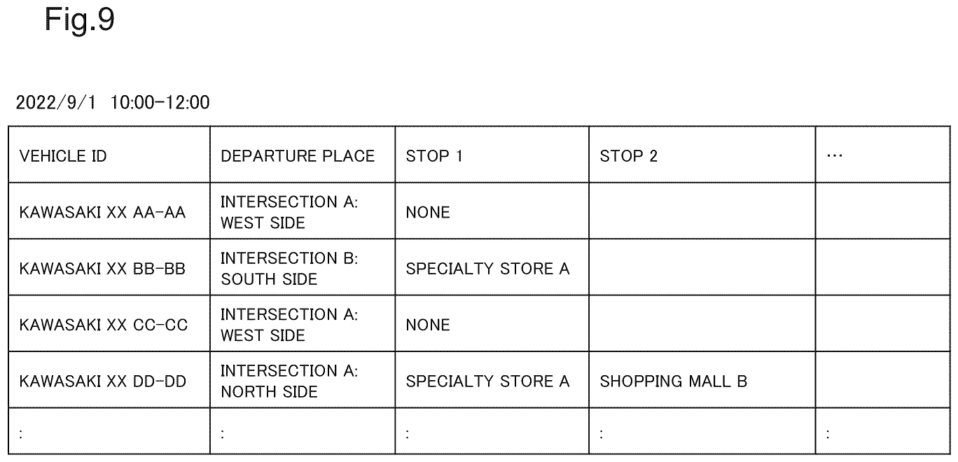

Referring to FIG. 8, first, when the counting time zone arrives, the visitor analysis system 100 performs visitor counting for each time zone by using the visitor analysis information (step S201). FIG. 9 is a diagram illustrating an example of the visitor counting information for each time zone counted by the visitor analysis system 100. In the example of FIG. 9, the movement (visit route) of the vehicles entering the parking lot between 10:00 and 12:00 on Sep. 1, 2022 is counted. By checking the departure place field of such data, it is possible to grasp an area (region) from which a customer who has come in a specific time zone of a certain date and time has come. It is possible to grasp a facility that a customer who has come to the commercial facility has stopped by before visiting the commercial facility by referring to the stop field in FIG. 9. For example, as illustrated in FIG. 9, in a case where there are many customers who stop by the specialty store A, it is conceivable that there is no specialty store similar to the specialty store A in the commercial facility. In such a case, it is possible to increase the number of visitors to the commercial facility or increase the stay time of the visitors by attracting a new specialty store or periodically opening an event for selling products equivalent to those of the specialty store A.

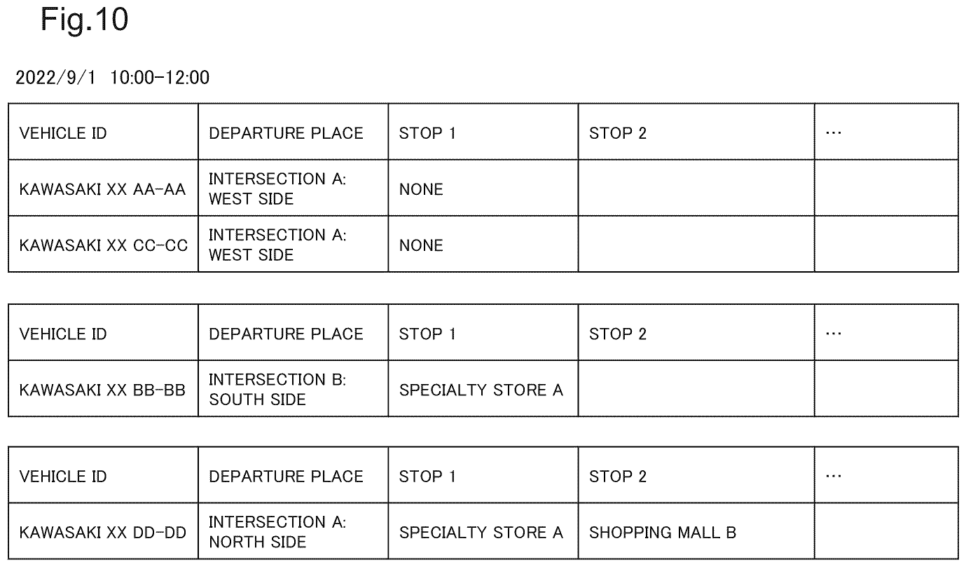

In the example of FIG. 8, the visitor analysis system 100 counts the number of visitors for each time zone, and then counts the number of visitors for each departure place (step S202). FIG. 10 is a diagram illustrating an example of the visitor counting information for each departure place counted by the visitor analysis system 100. In the example of FIG. 10, the movement (visit route) of the vehicle is counted for each departure place such as “intersection A west side”, “intersection B south side”, and “intersection A north side”. By checking the stop field of such data, it is possible to grasp the behavior tendency of the customer for each departure place. For example, in the example of FIG. 10, in a group having “intersection A west side” as a departure place, there are many customers who directly visit the commercial facility, but the customers of other departure places visit the facility after stopping by another facility. In such a case, for example, in order to enhance the attraction of the commercial facility for a group having “intersection A north side” as a departure place, a contention analysis with the shopping center B is performed, or a coupon is distributed to the group, so that it is possible to increase the number of visitors to the commercial facility or increase the stay time of the visitor.

As described above, according to the present example embodiment, it is possible to perform behavior analysis including not only a departure place of a visitor to a commercial facility but also a stop. In the example of FIG. 5, a form is used in which the visitor analysis system 100 and the image recording device 300 are independent as separate devices, but a configuration in which the visitor analysis system 100 and the image recording device 300 are integrated can also be used. In this case, the visitor analysis system 100 directly acquires an image from the camera, records the image, and uses the image for future analysis.

### Second Example Embodiment

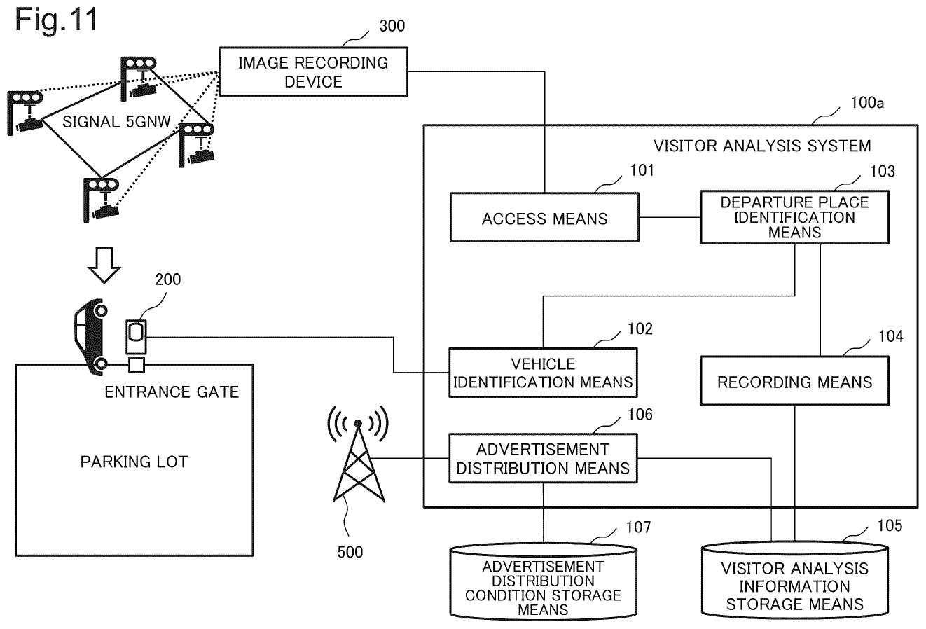

Next, the second example embodiment in which an advertisement distribution function is added to the visitor analysis system will be described. FIG. 11 is a block diagram illustrating a configuration of a visitor analysis system according to the second example embodiment of the present disclosure. The second example embodiment is different from the first example embodiment illustrated in FIG. 5 in that an advertisement distribution means 106 is added to a visitor analysis system 100a, and an advertisement distribution condition held in an advertisement distribution condition storage means 107 can be accessed. Other configurations and operations are the same as those of the first example embodiment, and thus description thereof is omitted.

The advertisement distribution means 106 creates an advertisement distribution condition (distribution plan) based on the visitor analysis information accumulated in the visitor analysis information storage means 105, and registers the distribution condition in the advertisement distribution condition storage means 107. The advertisement distribution means 106 distributes the advertisement via a base station 500 of the mobile communication network based on the created distribution condition (distribution plan). The advertisement information (content) to be distributed may be content of a moving image or a still image that can be displayed on an in-vehicle terminal or a portable terminal of a passenger of the vehicle, or may be audio content that can be output from a speaker or the like of the vehicle.

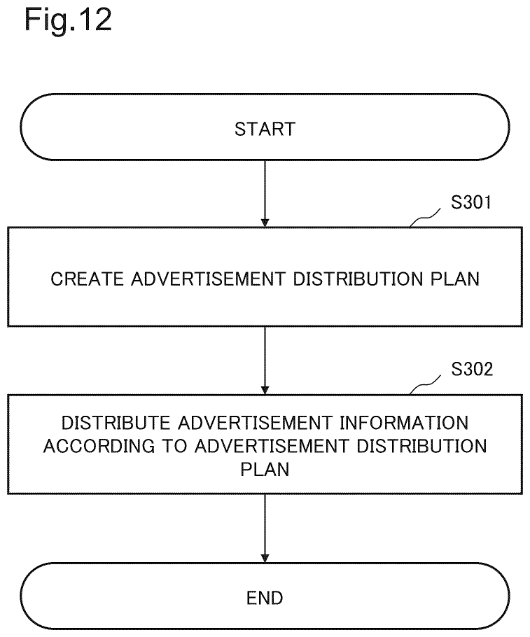

FIG. 12 is a flowchart illustrating an additional operation of the visitor analysis system according to the second example embodiment of the present disclosure. Referring to FIG. 12, first, the visitor analysis system 100a creates an advertisement distribution condition (distribution plan) based on the visitor analysis information (step S301).

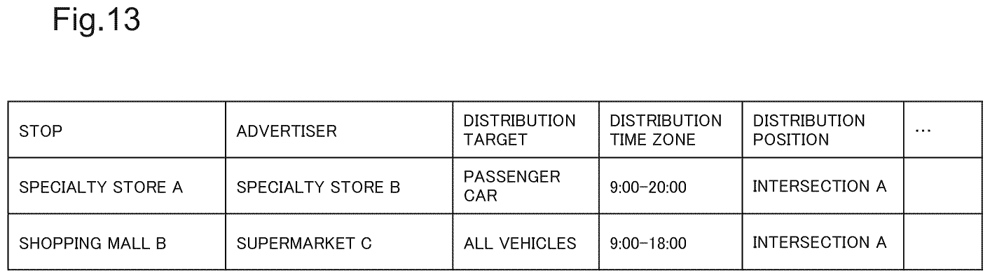

FIG. 13 is a diagram illustrating an example of the advertisement distribution condition (distribution plan) created by the visitor analysis system 100a of the present example embodiment. For example, the visitor analysis system 100a focuses on the fact that the specialty store A is often stopped by as the stop in the visitor analysis information, and makes a distribution plan to distribute advertisement content of a new specialty store B in a commercial facility in which a parking lot is installed. In the example of FIG. 13, a distribution plan is made to distribute advertisement content of the specialty store B for the passenger car at the intersection A at the time zone of 9:00 to 20:00. Similarly, in the example of FIG. 13, a distribution plan is made to distribute advertisement content of the supermarket C in the commercial facility for all vehicles at the intersection A in the time zone of 9:00 to 18:00. Such a distribution plan may be created by the visitor analysis system 100a, but may be manually created by an administrator or the like of the commercial facility with reference to the counting result illustrated in FIGS. 9 and 10.

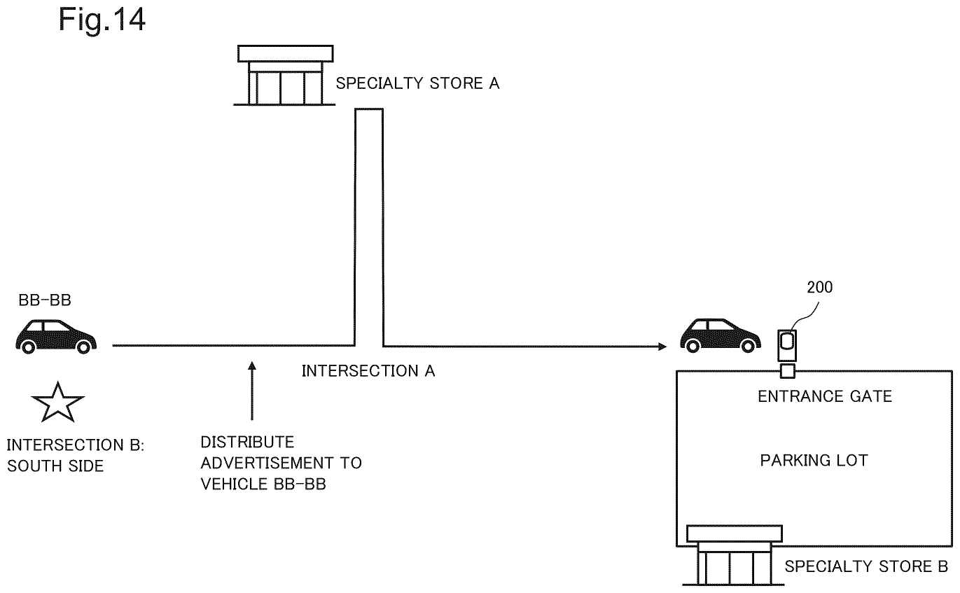

Next, the visitor analysis system 100a distributes advertisement information according to a distribution condition (distribution plan) of the created advertisement (step S302). FIG. 14 is a diagram illustrating an example of the advertisement distribution operation by the visitor analysis system 100a. For example, the visitor analysis system 100a distributes an advertisement to the vehicle BB-BB heading for a parking lot of a commercial facility after stopping by the specialty store A with the south side of the intersection B as a departure place. Specifically, the visitor analysis system 100a distributes the advertisement content of the specialty store B to the vehicle BB-BB approaching before the intersection A during the time set in the advertisement distribution condition. This makes it possible to motivate the passenger of the vehicle BB-BB to go to the specialty store B in the commercial facility instead of the specialty store A.

As a mechanism by which the visitor analysis system 100a distributes an advertisement to a vehicle at an intended position, a method using position information or the like of a terminal (vehicle) managed in the mobile communication network can be used. As a more desirable form, it is preferable that the visitor analysis system 100a can designate the moving direction of the terminal (vehicle) when distributing the advertisement information. In this way, it is possible to accurately distribute the advertisement information to the terminal (vehicle) moving in the direction of the commercial facility.

As described above, according to the present example embodiment, it is possible to distribute an advertisement based on a departure place or a stop of a vehicle that has entered a parking lot.

### Third Example Embodiment

In the first and second example embodiments described above, it is described that the visitor analysis system identifies the movement (visit route) of the vehicle that has entered the parking lot when the vehicle enters the parking lot, but the movement (visit route) of the vehicle may be identified when the vehicle exits from the parking lot. Hereinafter, the third example embodiment will be described in detail with reference to the drawings in which a movement (visit route) of a vehicle is identified in response to an exit from a parking lot.

In the first and second example embodiments, the departure place is identified by identifying the past movement (visit route) of the vehicle that has entered the parking lot, but in a case where it is assumed that the vehicle that has left the parking lot returns to the departure place, the departure place can also be estimated by tracking the vehicle that has left the parking lot. The visitor analysis system of the third example embodiment also estimates the departure place by tracking the vehicle that has left the parking lot based on such an assumption.

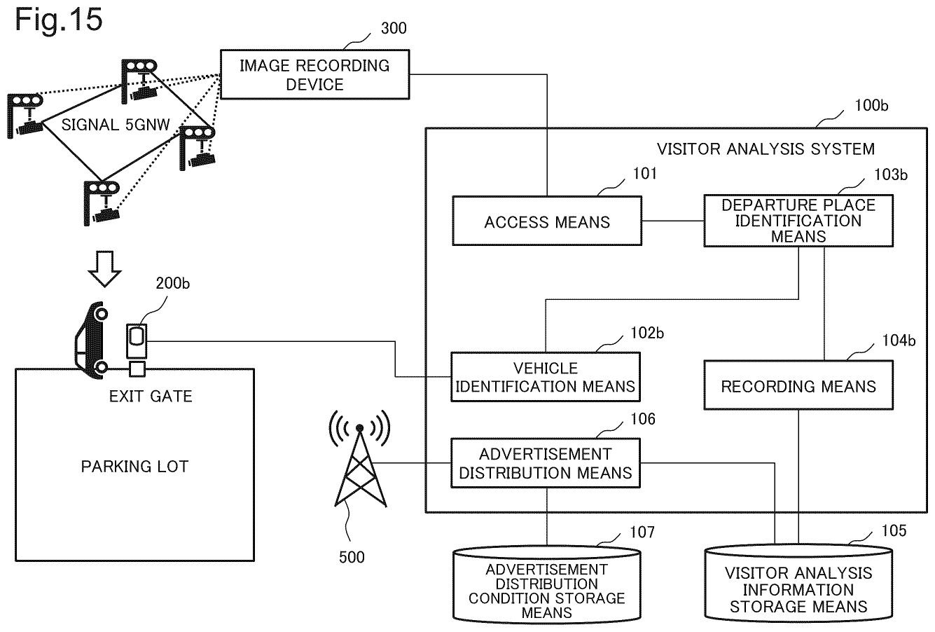

FIG. 15 is a block diagram illustrating a configuration of a visitor analysis system 100b according to the third example embodiment of the present disclosure. The third example embodiment is different from the second example embodiment illustrated in FIG. 11 in that, when a vehicle identification means 102b receives the license plate of the vehicle and the image of the vehicle that has left the parking lot from the exit gate device 200b, it transfers these pieces of information to a departure place identification means 103b, and requests the departure place identification means to identify the departure place.

Upon receiving the request for identifying a departure place from the vehicle identification means 102b, the departure place identification means 103b accesses the image recording device 300 via the image access means 101, monitors the past movement (visit route) of the vehicle whose departure place is requested to identify, and identifies the destination and the stop. More specifically, the departure place identification means 103b collates the vehicle identified by the vehicle identification means 102b with the image stored in the image recording device 300. Next, the destination is identified based on data of the time and data of the site stored in association with the matched image as a result of the collation. For example, a site imaged at the latest time in the day when the vehicle leaves the parking lot is identified as the destination. In tracking the position of the vehicle, a time for tracking may be limited. When the identification of the destination and the stop of the vehicle is completed, the departure place identification means 103b requests a recording means 104b to register the destination and the destination in the visitor analysis information storage means 105. Therefore, the departure place identification means 103b serves as a destination identification means for referring to an image captured by the camera group for the identified vehicle, and identifying a destination of the vehicle.

The recording means 104b registers, in the visitor analysis information storage means 105, data of a departure place and a stop of a vehicle that has left a parking lot. The recording means 104b uses the destination of the vehicle obtained by accessing the image recording device 300 and monitoring the movement of the vehicle as the departure place of the vehicle registered in the visitor analysis information storage means 105.

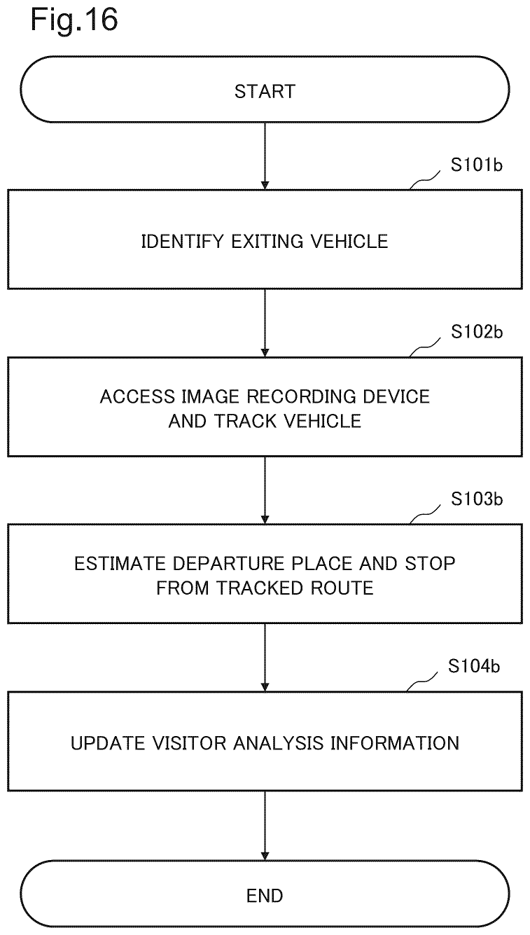

Next, the operation of the present example embodiment will be described in detail with reference to the drawings. FIG. 16 is a flowchart illustrating an operation of the visitor analysis system according to the third example embodiment of the present disclosure. Referring to FIG. 16, first, the visitor analysis system 100b identifies a vehicle that has left the parking lot (step S101b).

Next, the visitor analysis system 100b accesses the image recording device 300 and tracks the vehicle that has left the parking lot (step S102b).

Next, the visitor analysis system 100b estimates a departure place and a stop (in a case where there is a stop) of the vehicle that has left the parking lot based on the tracked movement (return) of the vehicle (step S103b).

Next, the visitor analysis system 100b registers information including the estimated departure place of the vehicle and the stop (in a case where there is a stop) in the visitor analysis information storage means 105 as visitor analysis information (step S104b). By performing the above processing, the visitor analysis system 100b of the present example embodiment can also obtain data as illustrated in FIG. 6.

Since subsequent operations are similar to those of the first and second example embodiments, the description thereof will be omitted. As described above, according to the present example embodiment, there is an advantage that the departure place of the vehicle can be estimated even in a case where the image storage period in the image recording device 300 is short. The reason is that the visitor analysis system 100b does not trace the past image, but employs a configuration in which the departure place is estimated by tracking the vehicle that has left the parking lot.

In the above description of the third example embodiment, it is described that the visitor analysis system 100b has an advertisement distribution function as in the second example embodiment, but it is also possible to change the configuration to a configuration in which the visitor analysis system 100b does not have an advertisement distribution function as in the first example embodiment.

### Fourth Example Embodiment

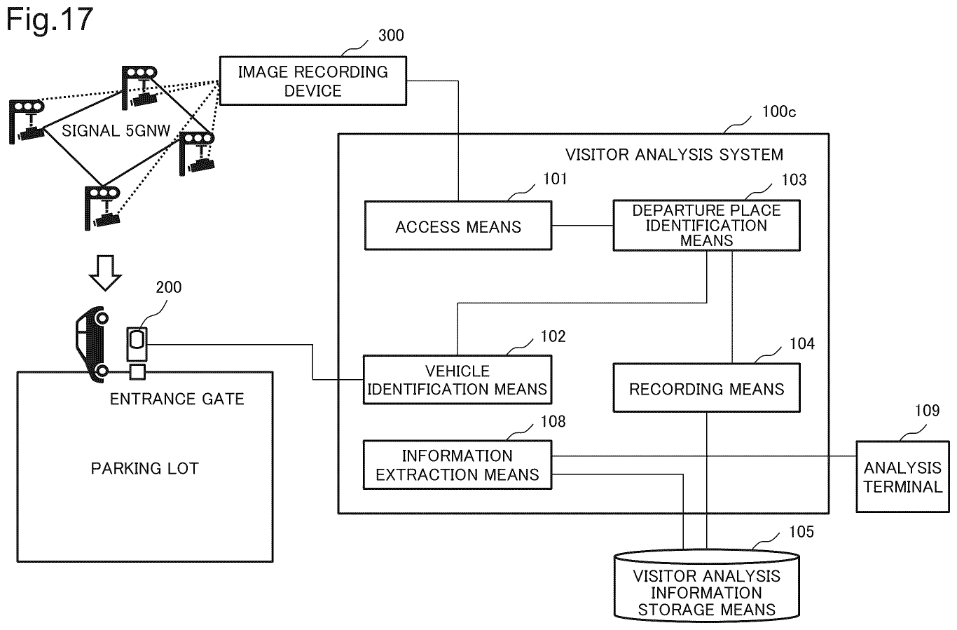

Although not particularly mentioned in the visitor analysis systems according to the first to third example embodiments, more advanced analysis can be performed by extracting desired information from the visitor analysis information. Hereinafter, the third example embodiment in which an information extraction means 108 is added to a visitor analysis system will be described in detail with reference to the drawings. FIG. 17 is a block diagram illustrating a configuration of a visitor analysis system 100c according to the fourth example embodiment of the present disclosure. The fourth example embodiment is different from the first example embodiment illustrated in FIG. 5 in that the information extraction means 108 is added to the visitor analysis system 100c in such a way that the visitor analysis information can be narrowed down for an external analysis terminal 109. Since the other configurations are similar to those of the first example embodiment, the differences thereof will be mainly described below.

The information extraction means 108 extracts information about a vehicle that meets a predetermined condition to transmit the extracted information to the analysis terminal 109. As the predetermined condition, a condition such as extracting a vehicle having a high frequency of entering the parking lot can be set.

As a result, the analysis terminal 109 can perform the visitor analysis narrowed down by the type and color of the vehicle, the region information of the license plate, and the like as the predetermined 0 condition.

For example, by selecting a vehicle having a high frequency of visiting to the commercial facility, it is possible to analyze in detail the behavior of the user group having a high frequency of visiting to the commercial facility. For example, by analyzing the departure place and the stop of such a user group, it is possible to plan an effective measure for improving the user satisfaction level and an effective advertisement method.

Similarly, by selecting a vehicle having a low frequency of visiting to the commercial facility, it is possible to analyze in detail the behavior of the user group having a low frequency of visiting to the commercial facility. In addition, more detailed analysis can be performed by narrowing down the visitor analysis information by using the region information about the vehicle type and the license plate in addition to the frequency of visiting to the commercial facility.

As described above, according to the present example embodiment, it is possible to analyze the visitor analysis information in more detail. Specifically, according to the present example embodiment, it is also possible to identify a departure place of an any vehicle by setting an any search condition from the analysis terminal 109 and making an inquiry to the information extraction means 108. For example, by designating and inquiring a specific number (a suspicious vehicle or a rental car), it is possible to obtain information about a departure place or a stop. As described above, the present disclosure can be used not only for marketing but also for security applications.

### Hardware Configuration

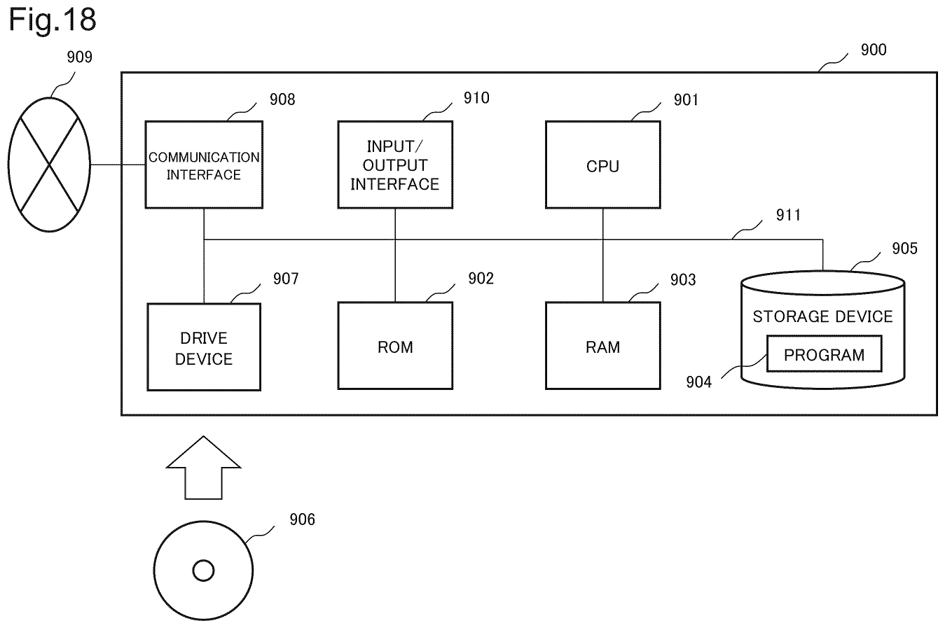

In each example embodiment of the present disclosure, each component of each device indicates a block of a functional unit. Part or all of each component of each device is achieved by, for example, an any combination of an information processing device 900 and a program as illustrated in FIG. 18. FIG. 18 is a block diagram illustrating an example of a hardware configuration of the information processing device 900 that achieves each component of each device. The information processing device 900 includes the following configuration as an example.
Central processing unit (CPU) 901
Read only memory (ROM) 902
Random access memory (RAM) 903
program 904 loaded into RAM 903
Storage device 905 storing program 904
Drive device 907 that reads and writes recording medium 906
Communication interface 908 connected with communication network 909
Input/output interface 910 for inputting/outputting data
Bus 911 connecting respective components

Each component of each device in respective example embodiments is achieved by the CPU 901 acquiring and executing the program 904 for achieving these functions. That is, the CPU 901 in FIG. 18 may access the image recording device 300 to execute a program for identifying a departure place of the vehicle and a program for configuring the visitor analysis information by using the result, and perform update processing of each calculation parameter held in the RAM 903, the storage device 905, or the like. The program 904 for achieving the function of each component of each device is stored in the storage device 905 or the ROM 902 in advance, for example, and is read by the CPU 901 as necessary. The program 904 may be supplied to the CPU 901 via the communication network 909, or may be stored in advance in the recording medium 906, and the drive device 907 may read the program and supply the program to the CPU 901.

The program 904 can display the processing result including the intermediate state for each stage via the display device as necessary, or can communicate with the outside via the communication interface. The program 904 can be recorded on a computer-readable (non-transitory) storage medium.

There are various modifications of the implementation method of each device. For example, each device may be achieved by an any combination of the information processing device 900 and the program separate for each component. A plurality of components included in each device may be achieved by any combination of one information processing device 900 and a program. That is, the present invention can be achieved by a computer program that causes a processor mounted in each of the devices described in the first to fourth example embodiments to execute each of the above-described processes using the hardware.

Part or all of each component of each device is achieved by another general-purpose or dedicated circuit, processor, or the like, or a combination thereof. These may be configured by a single chip or may be configured by a plurality of chips connected via a bus.

Part or all of each component of each device may be achieved by a combination of the above-described circuit or the like and the program.

In a case where part or all of each component of each device is achieved by a plurality of information processing devices, circuits, and the like, the plurality of information processing devices, circuits, and the like may be disposed in a centralized manner or in a distributed manner. For example, the information processing device, the circuit, and the like may be achieved as a form in which each of the information processing device, the circuit, and the like is connected via a communication network, such as a client and server system, a cloud computing system, and the like.

Each of the above-described example embodiments is a preferred example embodiment of the present disclosure, and the scope of the present disclosure is not limited only to each of the above-described example embodiments. That is, it is possible for those of ordinary skill in the art to make modifications and substitutions of the above-described example embodiments without departing from the gist of the present disclosure, and to construct a mode in which various modifications are made.

For example, in the above-described example embodiment, it is described that a technique used for traffic volume investigation, entrance/exit management of a parking lot, and the like is used as a mechanism for tracking a vehicle, but a vehicle tracking method is not limited to this method. For example, in a case where the above-described visitor analysis system can obtain license plate information about a vehicle passing through the “predetermined area”, a method of tracking the vehicle using the license plate information can be used. From the viewpoint of privacy and the like, it is also possible to adopt a method in which the above-described visitor analysis system tracks the vehicle using an image (image) of the vehicle without intentionally using the license plate information.

Some or all of the above example embodiments may be described as the following Supplementary Notes, but are not limited to the following.
[Supplementary note 1]

A visitor analysis system including
an access means for being capable of accessing an image recording device of an information system that includes a camera group that is dispersedly disposed in a predetermined area and images a vehicle traveling on a road in the area and the image recording device that stores an image captured by the camera group, data of a time at which the vehicle is imaged, and data of a site at which the vehicle is imaged in association with each other,
a vehicle identification means for identifying a vehicle that has entered a predetermined region, and
a departure place identification means for collating the identified vehicle with an image stored in the image recording device to identify a departure place of the vehicle based on data of the time and data of the site that have been associated with the matching image.
[Supplementary note 2]

The visitor analysis system described above may be configured to further include a storage means for recording the vehicle and a departure place of the vehicle in association with each other as visitor analysis information.
[Supplementary note 3]

The departure place identification means of the visitor analysis system described above may be configured to identify a departure place of the vehicle by tracking data of the time and data of the site associated with an image stored in the image recording device.
[Supplementary note 4]

The departure place identification means of the visitor analysis system described above may be configured to identify a departure place of the vehicle based on a site of the vehicle captured first during a period from a time when the vehicle enters the predetermined region to a time going back by a predetermined time.
[Supplementary note 5]

The departure place identification means of the visitor analysis system described above may further have a function of referring to an image stored in the image recording device and identifying a place that the vehicle has stopped by, and
the recording means may be configured to further record a place where the vehicle has stopped by in the visitor analysis information.
[Supplementary note 6]

The visitor analysis system described above may be configured to further include an information extraction means for extracting, based on the visitor analysis information, information about a vehicle that meets a predetermined condition or information about a vehicle having a high frequency of entering the region.
[Supplementary note 7]

The visitor analysis system described above
may be configured to transmit advertisement information to the vehicle based on a place that the vehicle has stopped by, the place being included in the visitor analysis information.
[Supplementary note 8]

A visitor analysis system including:
an image access means dispersedly disposed in a predetermined area and for being capable of accessing a camera group that images a vehicle traveling on a road in the area,
a vehicle identification means for identifying a vehicle that has left a predetermined region, and
a destination identification means for referring to an image captured by the camera group for the identified vehicle and identifying a destination of the vehicle.
[Supplementary note 9]

A visitor analysis method executed by a computer being capable of accessing an image recording device of an information system that includes a camera group that is dispersedly disposed in a predetermined area and images a vehicle traveling on a road in the area and the image recording device that stores an image captured by the camera group, data of a time at which the vehicle is imaged, and data of a site at which the vehicle is imaged in association with each other, the method including
identifying a vehicle that has entered a predetermined region, and
collating the identified vehicle with an image stored in the image recording device and identifying a departure place of the vehicle based on data of the time and data of the site that have been associated with the matching image.
[Supplementary note 10]

A visitor analysis method executed by a computer being capable of accessing a camera group dispersedly disposed in a predetermined area and imaging a vehicle traveling on a road in the area, the method including
identifying a vehicle that has left a predetermined region, and
referring to an image captured by the camera group and identifying a destination of the identified vehicle.
[Supplementary note 11]

A recording medium recording a program for causing a computer being capable of accessing an image recording device of an information system that includes a camera group that is dispersedly disposed in a predetermined area and images a vehicle traveling on a road in the area and the image recording device that stores an image captured by the camera group, data of a time at which the vehicle is imaged, and data of a site at which the vehicle is imaged in association with each other to execute the steps of
identifying a vehicle that has entered a predetermined region, and
collating the identified vehicle with an image stored in the image recording device and identifying a departure place of the vehicle based on data of the time and data of the site that have been associated with the matching image.
[Supplementary note 12]

A recording medium recording a program for causing a computer being capable of accessing a camera group dispersedly disposed in a predetermined area and imaging a vehicle traveling on a road in the area to execute the steps of
identifying a vehicle that has left a predetermined region, and
referring to an image captured by the camera group and identifying a destination of the identified vehicle.

The forms of the Supplementary Notes 9 to 12 can be expanded to the forms of the Supplementary Notes 2 to 8, as in the Supplementary Note 1.

The disclosure of the above PTL is incorporated herein by reference, and can be used as a basis or part of the present invention as necessary. Within the frame of the entire disclosure (including the claims) of the present invention, it is possible to change and adjust the example embodiments or examples further based on the basic technical idea thereof. Various combinations or selections (including partial deletions) of various disclosure elements (respective elements of each claim, respective elements of each example embodiment or example, respective elements of each drawing, and the like are included) can be made within the frame of the disclosure of the present invention. That is, it goes without saying that the present invention includes various modifications and corrections that can be made by those of ordinary skill in the art in accordance with the entire disclosure including the claims and the technical idea. Specifically, for numerical ranges set forth herein, any numerical value or sub-range included within the range should be construed as being specifically described, even in a case where not stated otherwise. Furthermore, it is also deemed that in the matters disclosed in the document cited above, using part or all of the matters disclosed in the document in combination with the matters described in the present specification as part of the disclosure of the present invention according to the gist of the present invention as necessary is included in the matters disclosed in the present application.

### REFERENCE SIGNS LIST

10, 100, 100a, 100b, 100c visitor analysis system
11, 101 access means
12, 102, 102b vehicle identification means
13, 103, 103b departure place identification means
104, 104b recording means
105 visitor analysis information storage means
20, 200, 200a entrance gate device
200b exit gate device
30, 300 image recording device
40 camera group
40-1, 40-2, 40-3, 40-4 camera
106 advertisement distribution means
107 advertisement distribution condition storage means
108 information extraction means
109 analysis terminal
500 base station
900 information processing device
901 central processing unit (CPU)
902 read only memory (ROM)
903 random access memory (RAM)
904 program
905 storage device
906 recording medium
907 drive device
908 communication interface
909 communication network
910 input/output interface
911 bus
V1, V2 vehicle

What is claimed is:

1. A visitor analysis system comprising:
at least one memory storing instructions; and
at least one processor configured to access the at least one memory and execute the instructions to:
access an image recording device of an information system that includes a camera group that is dispersedly disposed in a predetermined area and images a vehicle traveling on a road in the area and the image recording device that stores an image captured by the camera group, data of a time at which the vehicle is imaged, and data of a site at which the vehicle is imaged in association with each other;
identify a vehicle that has entered a predetermined region; and
collate the identified vehicle with an image stored in the image recording device to identify a departure place of the vehicle based on data of the time and data of the site that have been associated with the matching image.

2. The visitor analysis system according to claim 1, wherein
the at least one processor is further configured to execute the instructions to:
record the vehicle and a departure place of the vehicle in association with each other as visitor analysis information.

3. The visitor analysis system according to claim 1, wherein
the at least one processor is further configured to execute the instructions to:
identify a departure place of the vehicle by tracking data of the time and data of the site associated with an image stored in the image recording device.

4. The visitor analysis system according to claim 3, wherein
the at least one processor is further configured to execute the instructions to:
identify a departure place of the vehicle based on a site of the vehicle captured first during a period from a time when the vehicle enters the predetermined region to a time going back by a predetermined time.

5. The visitor analysis system according to claim 2, wherein
the at least one processor is further configured to execute the instructions to:
identify a place that the vehicle has stopped by, referring to an image stored in the image recording device; and
record a place that the vehicle has stopped by in the visitor analysis information.

6. The visitor analysis system according to claim 2, wherein
the at least one processor is further configured to execute the instructions to:
extract based on the visitor analysis information, information about a vehicle that meets a predetermined condition or information about a vehicle having a high frequency of entering the region.

7. The visitor analysis system according to claim 5, wherein
advertisement information is transmitted to the vehicle based on a place that the vehicle has stopped by, the place being included in the visitor analysis information.

8. The visitor analysis system according to claim 1, wherein
the at least one processor is further configured to execute the instructions to:
identify a vehicle that has left the predetermined region;
refer to an image captured by the camera group for the identified vehicle; and
identify a destination of the vehicle.

9. A visitor analysis method executed by a computer, the computer being capable of accessing an image recording device of an information system that includes a camera group that is dispersedly disposed in a predetermined area and images a vehicle traveling on a road in the area and the image recording device that stores an image captured by the camera group, data of a time at which the vehicle is imaged, and data of a site at which the vehicle is imaged in association with each other, the method comprising:
identifying a vehicle that has entered a predetermined region; and
collating the identified vehicle with an image stored in the image recording device and identifying a departure place of the vehicle based on data of the time and data of the site that have been associated with the matching image.

10. The visitor analysis method executed according to claim 1, further comprising:
identifying a vehicle that has left the predetermined region; and
referring to an image captured by the camera group and identifying a destination of the identified vehicle.

11. A non-transitory recording medium recording a program for causing a computer being capable of accessing an image recording device of an information system that includes a camera group that is dispersedly disposed in a predetermined area and images a vehicle traveling on a road in the area and the image recording device that stores an image captured by the camera group, data of a time at which the vehicle is imaged, and data of a site at which the vehicle is imaged in association with each other to execute the steps of:
identifying a vehicle that has entered a predetermined region; and
collating the identified vehicle with an image stored in the image recording device and identifying a departure place of the vehicle based on data of the time and data of the site that have been associated with the matching image.

12. The non-transitory recording medium recording the program according to claim 11, the program for causing the computer to execute the steps of:
identifying a vehicle that has left the predetermined region; and
referring to an image captured by the camera group and identifying a destination of the identified vehicle.
